(19) United States
(12) Patent Application Publication
(10) Pub. No.: US 2020/0298607 A1
(43) Pub. Date: Sep. 24, 2020

(54) DYE MIGRATION BARRIER FOR HEAT TRANSFER LABEL

(71) Applicant: Illinois Tool Works Inc., Glenview, IL (US)

(72) Inventors: Michael B. Colella, Southington, CT (US); Nicholas W. Penrose, Amston, CT (US)

(21) Appl. No.: 16/823,045

(22) Filed: Mar. 18, 2020

Related U.S. Application Data
(60) Provisional application No. 62/820,656, filed on Mar. 19, 2019.

(51) Int. Cl. B41M 5/382

(52) U.S. Cl. CPC B41M 5/38214

(57) ABSTRACT

A heat transfer label includes a carrier, a graphic layer, a barrier layer, and an adhesive layer. The barrier layer may be formed from a substantially solid formulation comprising a functional polyol component and a functional polyisocyanate component, wherein the functional polyol component and the functional polyisocyanate component reacts with each other to form the barrier layer configured to block dye migration.

### CROSS-REFERENCE TO RELATED APPLICATION DATA

This application claims the benefit of and priority to Provisional U.S. Patent Application Ser. No. 62/820,656, filed Mar. 19, 2019, titled DYE MIGRATION BARRIER FOR HEAT TRANSFER LABEL, the entirety of which is incorporated herein by reference.

### BACKGROUND

The present disclosure generally relates to heat transfer labels, and more particularly to heat transfer labels including an activated carbon-free dye migration barrier.

Heat transfer labels are well known and used in various industries. For example, heat transfer labels are used to transfer indicia formed from ink onto fabrics for decoration, cleaning instructions, sizes, and fabric composition to name a few. Typically, heat transfer labels include thermoplastic inks and/or adhesives that are heat-activated to adhere to fabrics. Heat transfer labels have replaced sewn-on patches in many fabric applications.

Dyes in colored fabrics can migrate or bleed to stain adjacent fabrics or labels. White indicia are especially susceptible to dye staining. Color fabrics produced using dye sublimation techniques are particularly challenging for heat transfer labels due to diffusion-driven dyes migrating from the fabric through the labels and altering the color and/or intended appearance of the indicia.

Therefore, many heat transfer labels include a barrier layer between the indicia layer and the fabric to prevent dye migration. Activated carbon is often used in the barrier layer. However, a relatively large quantity of activated carbon is required to prevent dye migration, and the dark black color of the activated carbon can bleed through to other layers. Further, activated carbon is a combustible dust, and thus, a heightened care is required for shipping and handling, which adds to the cost of manufacturing of labels using activated carbon. Furthermore, a relatively thick barrier layer including activated carbon barrier is needed to provide an effective dye-resistant layer. Typically, heat transfer labels include an activated carbon barrier layer having a minimum thickness of about 50 microns, which gives stiff and thick feel to the heat transfer labels.

Synthetic chemistries, such as silicone, are also used for a barrier layer. However, silicone in general can be difficult to use for heat-transfer type printing inks due to the low surface tension. As with the activated carbon barrier layer, a relatively thick layer of silicone barrier is needed to prevent dye migration, for example, a thickness of about 60-150 microns. Further, silicone is relatively expensive.

Accordingly, there is a need for an improved dye-migration barrier layer for heat transfer labels.

### BRIEF SUMMARY

A dye migration barrier for a heat transfer label may be formed from an environmentally friendly and substantially solid formulation according to various embodiments. The dye migration barrier may be formed as a colorless barrier, free of activated carbon. The dye migration barrier layer may be formulated with a functional polyol component and a functional polyisocyanate component, which may be cured to form a chemical resistant barrier layer effective for blocking dye migration from a substrate through a heat transfer label. The dye migration barrier may be used to form an environmentally friendly heat transfer label comprising a graphic layer formed from a substantially solid ink formulation and an adhesive layer formed from a substantially solid heat activated adhesive formulation. The heat transfer label may be configured to give off substantially zero volatile organic compounds (VOC) during printing processes and during application of the label to a substrate. Further, components of the heat transfer label may be formed from environmentally friendly ingredients, such as those from biorenewable sources.

In one aspect, a dye migration barrier for a heat transfer label formed from a substantially solid barrier formulation is provided. The barrier formulation may comprise a functional polyol component including a hydroxyl functional group and a functional polyisocyanate component including an isocyanate functional group, wherein the functional polyol component is configured to react with the functional polyisocyanate component and crosslink to form the dye migration barrier configured to block dye migration. In some embodiments, the dye migration barrier may be colorless.

The functional polyol component may be selected from the group consisting of sucrose, d-sorbitol, glucose, fructose, dextrose, and mixtures thereof. The functional polyisocyanate component may be selected from the group consisting of polymeric hexamethylene triisocyanate, polymeric isophorone triisocyanate, toluene diisocyanate, methylene diphenyl diisocyanate, and mixtures thereof. For example, the functional polyisocyanate component may be a blend of polymeric hexamethylene triisocyanate and polymeric isophorone triisocyanate.

The barrier formulation may also comprise at least one supporting polyol selected from the group consisting of castor oil derivatives, polyester diols, epoxy, polyether diols, cashew nut shell liquid derivatives, polyethylene glycol, polypropylene glycol, and hydroxyl-functional acrylics. In an embodiment, the barrier formulation may also comprise at least one catalysts selected from the group consisting of bismuth, aluminum mixed metals, amine, and strong acid. In such an embodiment, the dye migration barrier may include air pockets forming chemical-resistant cells therein. In some embodiments, the barrier formulation comprises at least one additive selected from the group consisting of polyamide, polydimethylsiloxane, ethoxylated alcohol, dodecane derivatives, and amines.

In an embodiment, the barrier formulation may comprise about 10 wt. % to about 30 wt. % of the functional polyol component and about 50 wt. % to about 85 wt. % of the functional polyisocyanate component. In another embodiment, the barrier formulation may comprise about 15 wt. % to about 25 wt. % of the functional polyol component, about 5 wt. % to about 15 wt. % of at least one supporting polyol, and about 0 wt. % to about 1 wt. % of a defoamer, and about 60 wt. % to about 80 wt. % of the functional polyisocyanate component. In yet another embodiment, the barrier formulation may comprise about 15 wt. % to about 25 wt. % of the functional polyol component, about 2 wt. % to about 10 wt. % of at least one supporting polyol, about 1 wt. % to about 5 wt. % of at least one specialty additive, about 0.1 wt. % to about 1 wt. % of a non-tin catalyst, and about 60 wt. % to about 80 wt. % of the functional polyisocyanate component.

In another aspect, a heat transfer label comprising a carrier, a graphic layer, a barrier layer, and an adhesive layer formed from a heat activated adhesive is provided. The heat transfer label may be configured such that the graphic layer is arranged on the carrier and the barrier layer is arranged between the graphic layer and the adhesive layer, wherein the graphic layer, the barrier layer, and the adhesive layer transfer to a substrate upon application of heat and pressure. When transferred, the graphic layer and the barrier layer may be attached to the substrate by the adhesive layer. The barrier layer may be formed from the dye migration barrier formed according to any of foregoing embodiments.

In an embodiment, the heat transfer label may be configured to be substantially free of volatile organic compounds and water. In such an embodiment, the graphic layer may include at least one ink layer formed from at least one substantially solid ink formulation, and the adhesive layer formed from a substantially solid heat activated adhesive formulation.

The at least one substantially solid ink formulation may be formulated using an ink base formed by mixing at least one first component containing a hydroxyl functional group and at least one second component containing an isocyanate functional group. The first component may be diol, polyol or a mixture thereof, and the second component may be diisocyanate, polyisocyanate, or a mixture thereof. For example, the at least one substantially solid ink formulation may comprise castor oil and an isocyanate crosslinker. In an embodiment, the at least one substantially solid ink formulation may be formulated with a polyurethane ink base, a polyamide ink base, polyester ink base, or polyether ink base.

The substantially solid heat activated adhesive formulation may be a hot melt adhesive powder or a mixture of hot melt adhesive powders. In an embodiment, the substantially solid heat activated adhesive formulation may comprise a substantially solid clear ink formulation and at least one hot melt adhesive powder.

Other aspects, objectives and advantages will become more apparent from the following detailed description when taken in conjunction with the accompanying drawings.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a schematic cross sectional view of a heat transfer label including a dye migration barrier layer according to an embodiment;

FIG. 2 is a schematic cross sectional view of the heat transfer label of FIG. 1 transferred to a substrate; and

FIG. 3 is a schematic top view of the heat transfer label of FIG. 1 on the substrate after a carrier is peeled off.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular.

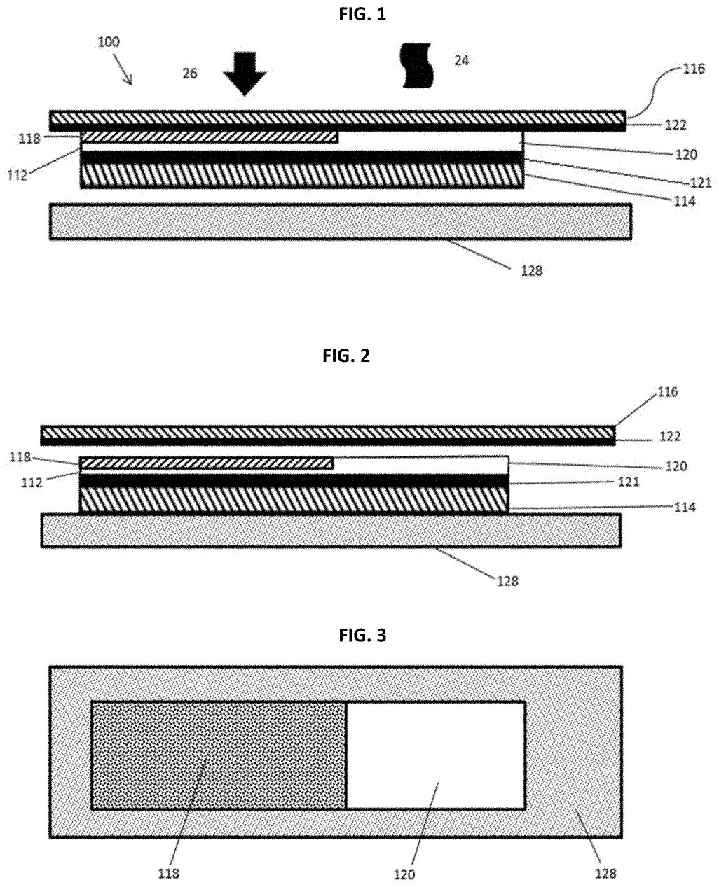

Referring to the figures, FIGS. 1-3 illustrate a heat transfer label 100 according to an embodiment. The heat transfer label 100 may generally include a graphic layer 112, a barrier layer 121, an adhesive layer 114 and a carrier 116. In the figures, layer thicknesses are exaggerated for easy understanding and are not proportional. The graphic layer 112 may include at least one ink layer 118, 120 formed from a suitable ink for heat transfer labels. The adhesive layer 114 may be formed from a suitable heat activated adhesive.

The barrier layer 121 may be arranged between the graphic layer 112 and the adhesive layer 114. The barrier layer 121 may be formulated to absorb or block migration of dyes including sublimation dyes from a substrate 128 into the graphic layer 112. The barrier layer 121 may be formed from a substantially solid formulation substantially free of VOC and water, which may be configured to provide a colorless barrier layer when cured to allow for more versatility in printing heat transfer labels.

In an embodiment, the barrier layer 121 may be formed from a solid formulation containing bio-renewable environmentally friendly raw materials. For example, the barrier layer 121 may be formed from a solid formulation free of water and solvent comprising a functional polyol component and a functional polyisocyanate component. In such an embodiment, the hydroxyl groups in the functional polyol component and the isocyanate groups in the functional polyisocyanate component may react to form a condensation polymer, such as polyurethane. The barrier layer 121 may be formed by applying such a solid formulation over the graphic layer 112 using a conventional printing technology, such as screen-printing, gravure, flexographic and lithographic printing, to provide a barrier layer 121 that is resistant to dye-migration including sublimation dye migration.

Suitable materials for the functional polyol component may include, but are not limited to, sucrose, d-sorbitol, glucose, fructose, dextrose, and mixtures thereof. Suitable materials for the functional polyisocyanate component may include, but are not limited to, hexamethylene diisocyanate, isophorone diisocyanate, toluene diisocyanate, methylene diphenyl diisocyanate, and mixtures thereof. The suitable materials for the functional polyol component have a relatively high functionality and a relatively low molecular weight, such that when cured, the barrier layer 121 may have a relatively high crosslink density to function as a chemical barrier. In an embodiment, the barrier layer 121 may be formed from a formulation having a total functionality of greater than about 2.3, and preferably greater than about 2.5, wherein the total functionality is defined as the total equivalents of reactive functional groups divided by the total moles of formulation. In an embodiment, the barrier layer 121 may be formed from a solid formulation comprising about 5 weight percent (wt. %) to about 40 wt. %, preferably about 10 wt. % to about 30 wt. %, and more preferably about 15 wt. % to about 25 wt. % of the functional polyol component, and about 40 wt. % to about 90 wt. %, preferably about 50 wt. % to about 85 wt. %, and more preferably about 60 wt. % to about 80 wt. % of the functional polyisocyanate component.

In some embodiments, the formulation for the barrier layer 121 may also comprise a catalyst. Suitable catalysts may include, but are not limited to, catalysts based on bismuth, aluminum mixed metals, amine, strong acid, and mixtures thereof. In such embodiments, the catalyst may create a foaming effect during curing to provide the barrier layer 121 comprising air pockets, which may form chemical-resistant cells in the barrier layer 121. The barrier layer 121 comprising such cells may create a tortuous fluid path through the barrier layer 121, thereby providing a physical barrier to prevent absorption of dyes, such as sublimation dyes, into the graphic layer 112.

In some embodiment, the formulation for the barrier layer 121 may include other ingredients to improve the properties of the barrier layer 121. For example, the formulation may contain one or more supporting polyols, which may be based on castor oil derivative, polyester diols, epoxy, polyether diols, cashew nut shell liquid derivatives, polyethylene glycol, polypropylene glycol, or hydroxyl-functional acrylics. Such ingredients may facilitate wetting of the functional polyol component to create a 2-part polyurethane system and may enhance flexibility of the barrier layer 121. Other suitable additives may include those that improve flow and leveling of the formulation, such as polyamide, polydimethylsiloxane, ethoxylated alcohol, dodecane derivatives, and amines.

The barrier layer 121 may be formed from a solid formulation including Part A and Part B, which may be configured to cure when mixed. In an embodiment, Part A may comprise about 15 wt. % to about 25 wt. % of the functional polyol component, such as sucrose, about 5 wt. % to about 15 wt. % of at least one supporting polyol, such as cardanol polyol and polypropylene glycol polyol, and about 0 wt. % to about 1 wt. % of a defoamer, such as dimethyl polysiloxane (e.g. Tego® Foamex N available from Evonik) or silicone emulsion (e.g. XIAMETER™ AFE-0100 Antifoam available from Dow), while Part B may comprise about 60 wt. % to about 80 wt. % of the functional polyisocyanate component, such as a blend of polymeric hexamethylene diisocyanate (e.g. biuret, uretidone and isocyanurate) and polymeric isophorone diisocyanate (“pHDI/pIPDI isocyanate blend”), wherein Part A and Part B make up about 100 wt. % of the solid formulation.

In another embodiment, Part A may comprise about 15 wt. % to about 25 wt. % of the functional polyol component, such as sucrose, about 2 wt. % to about 10 wt. % of at least one supporting polyol, such as cardanol polyol and cashew nut shell diol polyol, about 1 wt. % to about 5 wt. % of at least one specialty additive, such as polymeric dispersant (e.g. Solsperse™ 20000 available from Lubrizol, Zetasperse® 179 available from Evonik, and Disparlon® DA-325 available from Kusumoto Chmical, Ltd.), and about 0 wt. % to about 1 wt. % of a non-tin catalyst, such as aluminum chelate complex catalyst (e.g. K-Kat® 5218 available from King Industries, Inc.), bismuth carboxylate catalyst (e.g. K-Kat® XK-651 available from King Industries, Inc.) and zinc based catalyst (e.g. Reaxis® C622W78 available from Reaxis Inc.), while Part B may comprise about 60 wt. % to about 80 wt. % of the functional polyisocyanate component, such as pHDI/pIPDI isocyanate blend, wherein Part A and Part B make up about 100 wt. % of the solid formulation.

In an embodiment, the barrier layer 121 may have a thickness of about 10 microns to about 40 microns, preferably about 20 microns to about 30 microns. In an embodiment, the barrier layer 121 may also be formulated with a suitable hot melt adhesive powder. In such an embodiment, the barrier layer 121 may function as an adhesive layer and the adhesive layer 114 may be omitted. In some embodiments, the heat transfer label 100 may include more than one barrier layers.

In the embodiment of FIGS. 1-3, the graphic layer 112 includes two ink layers 118, 120 for a two-color design. In other embodiments, the graphic layer 112 may include one ink layer for a single-color design or more than two different color ink layers for a multicolor design. The graphic layer 112 may also include a top protective layer and/or a backing layer, such as a white backing layer. The first ink layer 118 may be a first color ink, e.g. yellow, and the second ink layer 120 may be a second color ink, e.g. white. In such an embodiment, a white color ink may be used as a back-up color to enhance the richness of the color of the first ink layer. For example, the white color ink may be used as the second ink layer 120 when the heat transfer label 100 having a lighter color ink as the first ink layer 118 is configured to be applied to darker colored substrates.

The graphic layer 112 may be formed from any suitable ink formulations. In an embodiment, the graphic layer 112 may be formed form an ink formulation containing a thermoplastic polymer. In some embodiments, the graphic layer 112 may be formed from at least one ink formulation, which is about 100% solid and substantially free of VOC and water. For example, the graphic layer 112 may be formed from polyurethane ink formulations that are substantially solid and substantially free of VOC and water. An ink base for such solid ink formulations may be prepared by mixing components containing hydroxyl functional groups with components containing isocyanate functional groups. In such an embodiment, the hydroxyl functional group and the isocyanate functional group may react to form a condensation polymer, such as polyurethane.

Suitable materials for the ink base components containing hydroxyl functional groups may include, but are not limited to, diols, polyols, and mixtures thereof. For example, castor oil is a commercially available natural oil that is suitable for the hydroxyl functional group containing component. Other natural oils suitable for the hydroxyl functional group containing component may include, but are not limited to, cashew nut oil and other similar natural oil polyols (NOP) or biopolyols, which may be modified to include hydroxyl groups. Suitable materials for the components containing isocyanate functional groups may include, but are not limited to, diisocyanates, polyisocyanates, and mixtures thereof. In some embodiments, monomeric alcohols may be added to control polymeric chain growth. Further, catalysts may also be added to accelerate the reaction, or blocked isocyanates may be used to inhibit the reaction until the isocyanates are unblocked.

The ink formulations formulated with such an ink base may yield flexible ink layers having excellent elastic properties, which may be stretched without fracturing and may return to their original shape after stretching. Such ink formulations may be well suited for labels used on apparel items, such as sports apparel. In other embodiments, the ink formulations may be modified by altering one or more components, for example, substituting aromatic counterparts to the aliphatic components, to provide hard, durable ink layers for application to rigid substrates, such as plastic jars and bottles, painted metal, and glasses. The ink formulations may be configured to cure at room temperature, such that the ink layers may be formed without heat and air flow as in a convection drying oven for curing solvent base inks or water base inks.

Other types of condensation reaction products or step growth polymerization products, such as polyamide, polyester, and polyether may be used as an ink base. Other suitable condensation reaction products that are suitable for the ink base may include, but are not limited to, reaction products between hydroxyls and carboxylic acids, reaction products between amines and epoxides, reaction products between amines and isocyanates, reaction products between amines and carboxylic acids, reaction products between hydroxyls and epoxides, and the likes. Copolymers formed from combinations of various raw materials may also be used as an ink base.

The ink bases prepared according to the foregoing embodiments may be used to formulate different color inks by adding various colorants, such as organic pigments, inorganic pigments, dyes, and the like. In some embodiments, an ink may be formulated with a mixture of different colorants. The ink bases may also be formulated with other additives.

The adhesive layer 114 may be formed from a substantially solid heat activated adhesive, which softens and forms a permanent bond with a substrate 128 when subjected to heat 24 and pressure 26. In an embodiment, a hot melt adhesive powder or a mixture of hot melt adhesive powders may be incorporated into a liquid ink formulation, such as the ink bases prepared according to the foregoing embodiments, and screen printed over the barrier layer 121 to form the adhesive layer 114. For apparel applications, the adhesive layer 114 may be configured to have a substantially greater thickness than the graphic layer 112. For example, the adhesive layer 114 can have a thickness of about 50-100 μm.

In another embodiment, the hot melt adhesive powder may be spread over a wet pass of a barrier layer followed by curing of the barrier layer, which may be followed by a second heat treatment to melt the hot melt adhesive powder to form a substantially uniform layer of hot melt adhesive. Such a sintering step may be carried out at temperatures determined according to the melt temperatures of the hot melt adhesive powders. Suitable hot melt adhesive powders include, but are not limited to, copolyester based hot melt adhesive, copolyamide hot melt adhesive, and polyurethane hot melt powder. In some embodiments, the heat transfer label 100 may be configured without a separate adhesive layer. In such embodiments, the barrier layer 121 may be formulated to provide adhesion to a substrate 128.

The graphic layer 112, the barrier layer 121, and the adhesive layer 114 may be printed on the carrier 116, for example, via a screen printing process. In such an embodiment, the graphic layer 112 may be printed on the carrier 116 first, and the barrier layer 121 and the adhesive layer 114 may be subsequently printed over the graphic layer 112. The graphic layer 112, the barrier layer 121 and the adhesive layer 114 may also be printed using other conventional printing methods, such as flexographic, rotogravure, or pad printing methods. The graphic layer 112, the barrier layer 121, and the adhesive layer 114 may be printed via a single or multiple printing passes. In some embodiments, the graphic layer 112 may be printed via multiple passes to provide a multi-color design. Further, the graphic layer 112 may also include a protective layer and/or a backing layer, which may be printed by additional printing passes. In some embodiments, the graphic layer 112 can include more than one backer colors.

The graphic layer 112 may be configured such that the affinity between the ink layers 118, 120, i.e. the inter-coat adhesion between the ink layers 118, 120, is greater than the affinity of either of the ink layers 118, 120 to the carrier 116 or the release layer 122, such that the graphic layer 112, the barrier layer 121, and the adhesive layer 114 may transfer to a substrate 128 when subjected to heat 24 and pressure 26. Further, the affinity between the ink layers 118, 120 and the barrier layer 121 may be configured to be greater than the affinity of the ink layers 118, 120 for the carrier 116 or the release layer 122.

The carrier 116 may be formed from a suitable material, such as a paper or a polymeric film. Suitable polymeric films for the carrier 116 may include a polypropylene film and a polyester film, with polyester being more heat resistant. MYLAR® and MELINEX® are two trademarks under which these materials are commercially available. Paper may be less costly than plastic films. However, the dimensional stability of paper may be less desirable unless printing is conducted in a controlled environment with regard to temperature and relative humidity. The gloss of the heat transfer label 100 after application to a substrate may be controlled by the gloss of the carrier 116. For example, a carrier having a flat and smooth printing surface may provide a glossy graphic layer, while a carrier having a matte printing surface may provide a graphic layer having a matter surface.

In some embodiments, the carrier 116 may be coated with a release layer 122. The release layer 122 may be formed from a silicone based material or other coating materials having a low surface tension. In an embodiment, both sides of the carrier 116 may be coated with release coatings, wherein the release coatings have different release characteristics. For example, the printed side may have a tighter release than the non-printed side.

In use, the heat transfer label 100 may be placed on a substrate 128, for example, a shirt fabric, such that the adhesive layer 114 faces the substrate 128 as shown in FIG. 1. To transfer the label, heat 24 and pressure 26 may be applied over the carrier 116 with a label applicator. When heat 24 and pressure 26 are applied, the adhesive layer 114 may soften and adhere to the substrate 128 permanently. Subsequently, the carrier 116 may be peeled off. Since the adhesion strength between the graphic layer 112 and the barrier layer 121 is greater than that between the graphic layer 112 and the carrier 116 and/or the release layer 122, the graphic layer 112 remains attached to the barrier layer 121 and the adhesive layer 114, and transfers to the substrate 128. As shown in FIG. 2, the release layer 122 remains bonded to the carrier 116 and stripped away from the graphic layer 112 when the carrier 116 is peeled away.

FIG. 3 is a schematic top view of the two ink layers 118, 120 of the graphic layer 112 attached to the substrate 128. In other embodiments, the graphic layer 112 may include a one ink layer for a single-color design or may include more than two ink layers for a multi-color design.

In an embodiment, the heat transfer label 100 may be configured as an apparel label for apparel made with fabric that has been colored with migration susceptible dyes, such as sublimation dyes. In such an embodiment, the barrier layer 121 may be configured to block dye migration from the fabric substrate, for example, a fabric colored with a red dye, into the ink layer 120, which may be formed from a white ink formulation, preventing the ink layer 120 from becoming a pink background layer instead of a white background layer.

Example of Barrier Layer Formulations:

TABLE 1
Dye Migration Barrier Formula 1

| | |
|---|---|
| Raw Material Type | Weight Percent |

Part A

| | |
|---|---|
| Cardanol Polyol | 5-10% |
| Sucrose | 15-25% |
| dimethyl polysiloxane defoamer | 0-1% |

Part B

| | |
|---|---|
| pHDI/pIPDI Isocyanate Blend | 60-80% |
| TOTAL | 100% |

TABLE 2
Dye Migration Barrier Formula 2

| | |
|---|---|
| Raw Material Type | Weight Percent |

Part A

| | |
|---|---|
| Polypropylene Glycol Polyol | 5-10% |
| Cardinol Polyol | 1-5% |
| Sucrose | 15-25% |
| dimethyl polysiloxane defoamer | 0-1% |

Part B

| | |
|---|---|
| pHDI/pIPDI Isocyanate Blend | 60-75% |
| TOTAL | 100% |

TABLE 3
Dye Migration Barrier Formula 3

| | |
|---|---|
| Raw Material Type | Weight Percent |

Part A

| | |
|---|---|
| Cashew Nut Shell Diol Polyol | 1-5% |
| Cardinol Polyol | 1-5% |
| Sucrose | 15-25% |
| Polymeric Dispersant | 1-5% |
| Bismuth Carboxylate Catalyst | 0-1% |

Part B

| | |
|---|---|
| pHDI/pIPDI Isocyanate Blend | 60-80% |
| TOTAL | 100% |

Example of Ink Formulations:

TABLE 4
Ink Formula 1 - Clear Base

| Raw Material Type | Weight Percent |
|---|---|
| Castor Oil-Based Resins | 25-50% |
| Polyester Diol Resin | 5-15% |
| Surface Tension Additive | 1-2% |
| Defoaming Additive | 1.5-3% |
| Moisture Scavenger | 2-4% |
| Thixotropic Additive | 0.3-0.6% |
| Aluminum Catalyst | 1-2% |

Cross-linked With

| | |
|---|---|
| HDI/IPDI Isocyanate Crosslinker | 20-40% |
| TOTAL | 100% |

TABLE 5
Ink Formula 2 - White

| Raw Material | Weight Percent |
|---|---|
| Castor Oil-Based Resins | 25-40% |
| Polyester Diol Resin | 2-10% |
| Surface Tension Additive | 0.5-1% |
| Moisture Scavenger | 1-2% |
| Titanium Dioxide Pigment | 15-30% |
| Pigment Extender | 10-20% |
| Defoaming Additive | 2-3% |
| Aluminum Catalyst | 2-3% |

Cross-linked With

| | |
|---|---|
| HDI/IPDI Isocyanate Crosslinker | 15-30% |
| TOTAL | 100% |

TABLE 6
Ink Formula 3 - Clear Base

| Raw Material | Weight Percent |
|---|---|
| Cashew Shell Resin | 20-40% |
| Polyester Diol Resin | 10-20% |
| Castor Oil-Based Resins | 10-20% |
| Surface Tension Additive | 0.5-1% |
| Defoaming Additive | 1-2% |
| Thixotropic Additive | 0.5-1% |
| Aluminum Catalyst | 1-2% |

Cross-linked With

| | |
|---|---|
| HDI/IPDI Isocyanate Crosslinker | 25-50% |
| TOTAL | 100% |

The clear base formulations of TABLE 4 and 6 (Formula 1 and Formula 3) may be used to formulate ink formulations for the ink layers 118, 120 and adhesive formulations for the adhesive layers 114. The white ink formulation of TABLE 5 (Formula 2) may be used to form a backing layer of the graphic layer 112, or any of the ink layers 118, 120.

In the present disclosure, the words “a” or “an” are to be taken to include both the singular and the plural. Conversely, any reference to plural items shall, where appropriate, include the singular. It will be appreciated by those skilled in the art that the relative directional terms such as upper, lower, rearward, forward and the like are for explanatory purposes only and are not intended to limit the scope of the disclosure.

All patents or patent applications referred to herein, are hereby incorporated herein by reference, whether or not specifically done so within the text of this disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A dye migration barrier for a heat transfer label formed from a substantially solid barrier formulation comprising a functional polyol component including a hydroxyl functional group and a functional polyisocyanate component including an isocyanate functional group, wherein the functional polyol component is configured to react with the functional polyisocyanate component and crosslink to form the dye migration barrier configured to block dye migration.

2. The dye migration barrier of claim 1, wherein the functional polyol component is selected from the group consisting of sucrose, d-sorbitol, glucose, fructose, dextrose, and mixtures thereof.

3. The dye migration barrier of claim 1, wherein the functional polyisocyanate component is selected from the group consisting of polymeric hexamethylene triisocyanate, polymeric isophorone triisocyanate, toluene diisocyanate, methylene diphenyl diisocyanate, and mixtures thereof.

4. The dye migration barrier of claim 1, wherein the barrier formulation further comprises at least one catalysts selected from the group consisting of bismuth, aluminum mixed metals, amine, and strong acid.

5. The dye migration barrier of claim 4, wherein the dye migration barrier comprises air pockets forming chemical-resistant cells.

6. The dye migration barrier of claim 1, wherein the barrier formulation further comprises at least one supporting polyol selected from the group consisting of castor oil derivatives, polyester diols, polyether diols, cashew nut shell liquid derivatives, polyethylene glycol, polypropylene glycol, and hydroxyl-functional acrylics

7. The dye migration barrier of claim 1, wherein the barrier formulation comprises about 10 wt. % to about 30 wt. % of the functional polyol component and about 50 wt. % to about 85 wt. % of the functional polyisocyanate component.

8. The dye migration barrier of claim 1, wherein the barrier formulation comprises about 15 wt. % to about 25 wt. % of the functional polyol component, about 5 wt. % to about 15 wt. % of at least one supporting polyol, and about 60 wt. % to about 80 wt. % of the functional polyisocyanate component.

9. The dye migration barrier of claim 1, wherein the barrier formulation comprises about 15 wt. % to about 25 wt. % of the functional polyol component, about 2 wt. % to about 10 wt. % of at least one supporting polyol, about 0.1 wt. % to about 1 wt. % of a non-tin catalyst, and about 60 wt. % to about 80 wt. % of the functional polyisocyanate component.

10. The dye migration barrier of claim 1, wherein the functional polyisocyanate component is a blend of polymeric hexamethylene triisocyanate and polymeric isophorone triisocyanate.

11. The dye migration barrier of claim 1, wherein the dye migration barrier is colorless.

12. A heat transfer label, comprising:
a carrier;
a graphic layer provided on the carrier;
an adhesive layer formed from a heat activated adhesive; and
a barrier layer formed from the dye migration barrier of any of claims 1-11 and arranged between the graphic layer and the adhesive layer,
wherein the heat transfer label is configured such that the graphic layer, the barrier layer, and the adhesive layer transfer to a substrate upon application of heat and pressure, wherein the graphic layer and the barrier layer is attached to the substrate by the adhesive layer.

13. The heat transfer label of claim 12, wherein the heat transfer label is configured to be substantially free of volatile organic compounds and water, wherein the graphic layer includes at least one ink layer formed from at least one substantially solid ink formulation, and wherein the adhesive layer is formed from a substantially solid heat activated adhesive formulation.

14. The heat transfer label of claim 13, wherein the at least one substantially solid ink formulation is formulated using an ink base formed by mixing at least one first component containing a hydroxyl functional group and at least one second component containing an isocyanate functional group.

15. The heat transfer label of claim 14, wherein the first component is diol, polyol or a mixture thereof, and the second component is diisocyanate, polyisocyanate, or a mixture thereof.

16. The heat transfer label of claim 14, wherein the first component includes castor oil.

17. The heat transfer label of claim 13, wherein the at least one substantially solid ink formulation is formulated with a polyurethane ink base, a polyamide ink base, polyester ink base, or polyether ink base.

18. The heat transfer label of claim 13, wherein the at least one substantially solid ink formulation comprises castor oil and an isocyanate crosslinker.

19. The heat transfer label of claim 13, wherein the substantially solid heat activated adhesive formulation is a hot melt adhesive powder or a mixture of hot melt adhesive powders.

20. The heat transfer label of claim 13, wherein the substantially solid heat activated adhesive formulation comprise a substantially solid clear ink formulation and at least one hot melt adhesive powder.
